(19) United States
(12) Patent Application Publication
(10) Pub. No.: US 2009/0091552 A1
(43) Pub. Date: Apr. 9, 2009

(54) TOUCH PANEL AND CONTROL METHOD THEREOF

(75) Inventor: Kuo-Sheng LEE, Tainan County (TW)

Correspondence Address: LOWE HAUPTMAN HAM & BERNER, LLP, 1700 DIAGONAL ROAD, SUITE 300, ALEXANDRIA, VA, 22314, US

(73) Assignee: CHI MEI OPTOELECTRONICS CORP., Tainan County (TW)

(21) Appl. No.: 12/117,350

(22) Filed: May 8, 2008

(30) Foreign Application Priority Data
Oct. 5, 2007 (TW) 96137575

(51) Int. Cl. G06F 3/045

(52) U.S. Cl. 345/174

(57) ABSTRACT

In a touch panel having at least one pixel and/or in accordance with a method of controlling the touch panel, a first bias signal is sent to a touch-sensitive sensing capacitor of the pixel during a first time period to charge the sensing capacitor with a sensing charge. The charged sensing capacitor discharges the sensing charge, as an outputted second bias signal, during a second time period. Based on the second bias signal, a determination is made as to whether the capacitance of the sensing capacitor has changed between the first and second periods, thereby indicating whether the pixel of the touch panel has been touched.

This application claims the benefit of Taiwan application Serial No. 96137575, filed Oct. 5, 2007, the entirety of which is incorporated herein by reference.

### BACKGROUND

1. Technical Field

The disclosure relates to a panel and a control method, and, in particular, to a touch panel and a control method thereof.

2. Related Art

With the recent advancement of technology, various information apparatuses have been continuously upgraded. Taking a data input apparatus as an example, inputting the data through a keyboard or a mouse and outputting the data through a display appear to be too slow because the current data processing amount gradually grows with each passing day.

In addition to the visual sense and the acoustic sense, the human still possesses the tactile sense, so a touch sensor has become another choice for the communication between the human and the information apparatus with the continuous update of the sensor technology.

On the other hand, the conventional computer input interface, such as the keyboard or the mouse, cannot be easily operated by a user who is not familiar with the computer so that the popularization of the computer is limited. In order to operate the information apparatus more instinctively, the manufacturers have recently developed touch panels. The touch panel has the property of human-oriented input interface so that the user with any age can directly select the functional options on the touch panel with his/her finger or a touch pen (stylus).

In a conventional touch panel, a touch film (an outer film) is added onto the conventional display panel to sense the touched position. However, this configuration increases material costs and decreases the brightness of the panel.

Recently, the manufacturers have developed an in-cell touch panel having a photonic transistor, which is manufactured in the panel by the thin film transistor manufacturing process, for sensing the touched position. The principle of such in-cell touch panel is that different signals are generated when the photonic transistor is illuminated or is not illuminated by light. Thus, a rear end control unit can obtain the position touched by the user.

However, when the touch panel is placed in an environment with a flickering external light source or a weak external light source, the touch panel may be malfunctioned. In addition, the lifespan of the photonic transistor is also restricted due to the action of light.

Therefore, it is important to provide a touch panel and a control method thereof, which can be free from interferences caused by external light rays and have a lengthened service life.

### SUMMARY

In an embodiment, the invention discloses a touch panel, comprising: a controller; at least one pixel and a sense reading unit. The pixel comprises a touch choosing switch coupled to and controlled by the controller to turn on during a first time period and turn off during a second time period; a read switch coupled to and controlled by the controller to turn off during the first time period and turn on during the second time period; and a sensing capacitor having a touch-sensitive capacitance and being electrically connected with the touch choosing switch and the read switch to be charged, via the touch choosing switch, with a sensing charge during the first time period and to discharge the sensing charge, via the read switch during the second time period. The sense reading unit is electrically connected with the sensing capacitor via the read switch for outputting a sensed output value during the second time period. The sensed output value is indicative of the whether the capacitance of the sensing capacitor has changed between the first and second periods, thereby indicating whether said pixel of the touch panel has been touched.

In another embodiment, the invention also discloses a touch panel comprising at least one pixel having a first scan line, a second scan line, and a bias line. The pixel further comprises a touch choosing switch, a read switch, and a sensing capacitor having a touch-sensitive capacitance. The touch choosing switch is electrically connected with the first scan line and the bias line. The read switch is electrically connected with the second scan line. The sensing capacitor is electrically connected with both the touch choosing switch and the read switch, for receiving a first bias signal from the bias line through the touch choosing switch during a first period and for outputting a second bias signal through the read switch during a second period different from the first period. The second bias signal is indicative of the whether the capacitance of the sensing capacitor has changed between the first and second periods, thereby indicating whether said pixel of the touch panel has been touched.

In a further embodiment, the invention further discloses a control method of a touch panel having at least one pixel that comprises a sensing capacitor having a touch-sensitive capacitance. The control method comprises transmitting a first bias signal to the sensing capacitor during a first time period to charge the sensing capacitor with a sensing charge; causing the sensing capacitor to discharge the sensing charge as an outputted second bias signal during a second time period different from the first time period; and based on the second bias signal, determining whether the capacitance of the sensing capacitor has changed between the first and second periods, thereby indicating whether said pixel of the touch panel has been touched.

Additional aspects and advantages of the disclosed embodiments are set forth in part in the description which follows, and in part are apparent from the description, or may be learned by practice of the disclosed embodiments. The aspects and advantages of the disclosed embodiments may also be realized and attained by means of the instrumentalities and combinations particularly pointed out in the appended claims.

### BRIEF DESCRIPTION OF THE DRAWINGS

Embodiments of the invention will become more fully understood from the detailed description and accompanying drawings, which are given for illustration only, and thus are not limitative of the present invention, and wherein:

FIG. 1 is a schematic illustration showing a touch panel according to a first embodiment of the invention;

FIG. 2 is a schematic illustration showing a pixel according to the first embodiment of the invention;

FIG. 3 is a schematic illustration showing a control method of the touch panel according to the first embodiment of the invention;

FIG. 4 is a schematic illustration showing a timing control of the touch panel according to the first embodiment of the invention;

FIGS. 5A and 5B are schematic illustrations showing alternative structures of a sensing capacitor of the touch panel according to the first embodiment of the invention;

FIG. 6 is a schematic illustration showing a touch panel according to a second embodiment of the invention;

FIG. 7 is a schematic illustration showing a pixel according to the second embodiment of the invention;

FIG. 8 is a schematic illustration showing a control method of the touch panel according to the second embodiment of the invention;

FIG. 9 is a schematic illustration showing a timing control of the touch panel according to the second embodiment of the invention; and

FIGS. 10 and 11 show connections between a liquid crystal capacitor and a storage capacitor of the touch panel.

### DETAILED DESCRIPTION OF EMBODIMENTS

Embodiments of the present invention will be apparent from the following detailed description, with reference to the accompanying drawings, wherein the same references relate to the same elements.

### First Embodiment

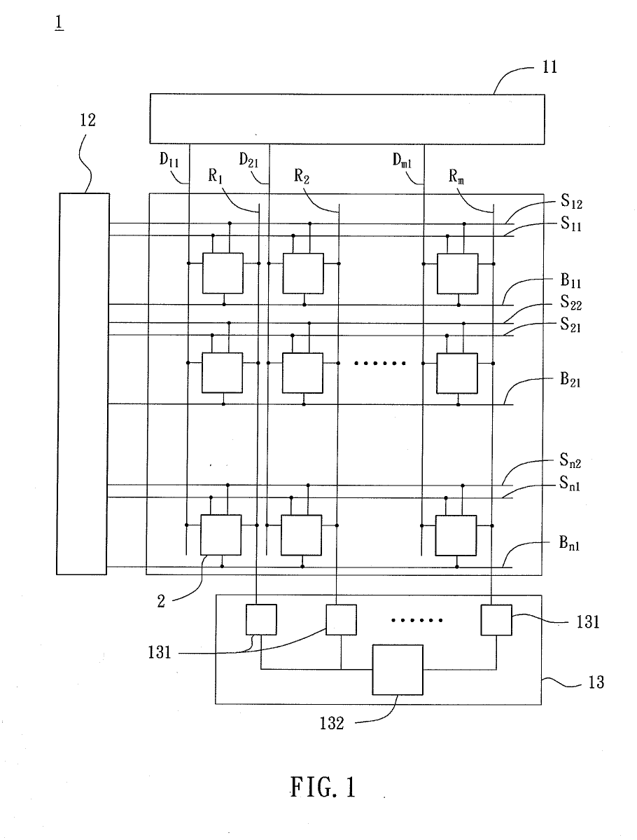

Referring to FIG. 1, a touch panel 1 according to a first embodiment of the invention includes a plurality of pixels 2, a data control circuit 11, a scan control circuit 12 and a touch control circuit 13. The data control circuit 11 is electrically connected with the corresponding pixels 2 through a plurality of data lines D₁₁ to Dₘ₁, and the scan control circuit 12 is electrically connected with the corresponding pixels 2 through a plurality of scan lines S₁₁ to Sₙ₂, wherein m and n are positive integers.

The touch control circuit 13 includes a plurality of sense reading units 131 and a position judging unit 132. The position judging unit 132 is electrically connected with the sense reading units 131, and the sense reading units 131 are electrically connected with the corresponding pixels 2 through a plurality of read lines R₁ to Rₘ.

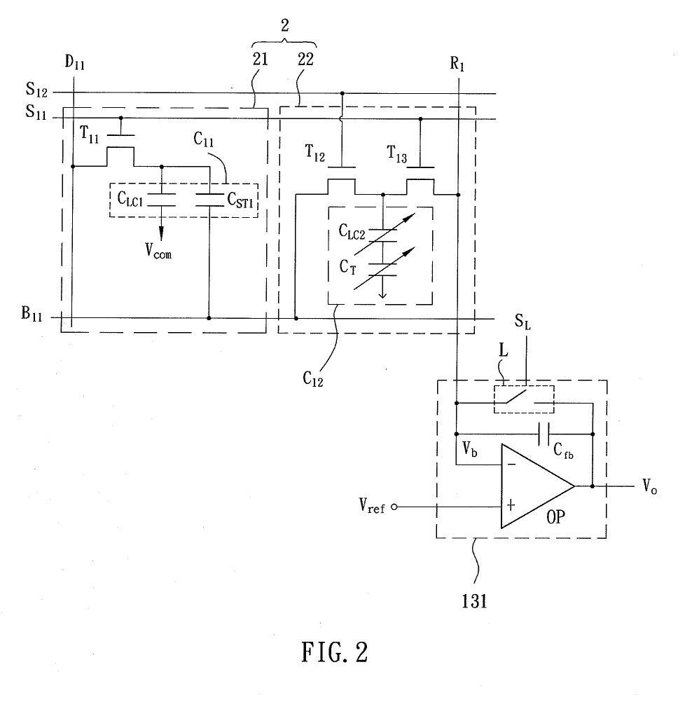

The pixels 2 are arranged on the touch panel in an array. Referring to FIG. 2, the pixel 2 according to the first embodiment of the invention includes a pixel unit 21 and a touch unit 22.

The pixel unit 21 has a pixel switch T₁₁ and a pixel sensing capacitor C₁₁. The pixel switch T₁₁ is electrically connected with the first scan line S₁₁, the data line D₁₁ and the pixel sensing capacitor C₁₁. In practice, the pixel sensing capacitor C₁₁ includes a liquid crystal capacitor C_{LC1} and a storage capacitor C_{ST1} electrically connected with each other. The storage capacitor C_{ST1} is electrically connected with and between the pixel switch T₁₁ and a bias line B₁₁, and the liquid crystal capacitor C_{LC1} is electrically connected with and between the pixel switch T₁₁ and a common electrode V_{com}.

The touch unit 22 has a touch choosing switch T₁₂, a read switch T₁₃ and a sensing capacitor C₁₂. The touch choosing switch T₁₂ is electrically connected with the second scan line S₁₂ and the bias line B₁₁. To be noted, the voltage applied to a bias line may be a DC or AC voltage. The sensing capacitor C₁₂ is electrically connected with the touch choosing switch T₁₂ and the read switch T₁₃. The sensing capacitor C₁₂ includes a liquid crystal capacitor C_{LC2} and a varactor C_{T}.

As shown in FIG. 2, the sense reading unit 131 is electrically connected with the read switch T₁₃. In practice, the sense reading unit 131 may be an integrator. In addition, the sense reading unit 131 may be disposed in the pixel 2 or the touch control circuit 13. In this illustrated embodiment, the sense reading unit 131 is integrated with the touch control circuit 13, for example.

In this embodiment, the sense reading unit 131 includes an operational amplifier OP, an operational capacitor C_{fb} and a switch L. The operational amplifier OP has a positive input terminal, a negative input terminal and an output terminal. The operational capacitor C_{fb} is electrically connected with and between the negative input terminal and the output terminal of the operational amplifier, and the switch L is connected with the operational capacitor C_{fb} in parallel.

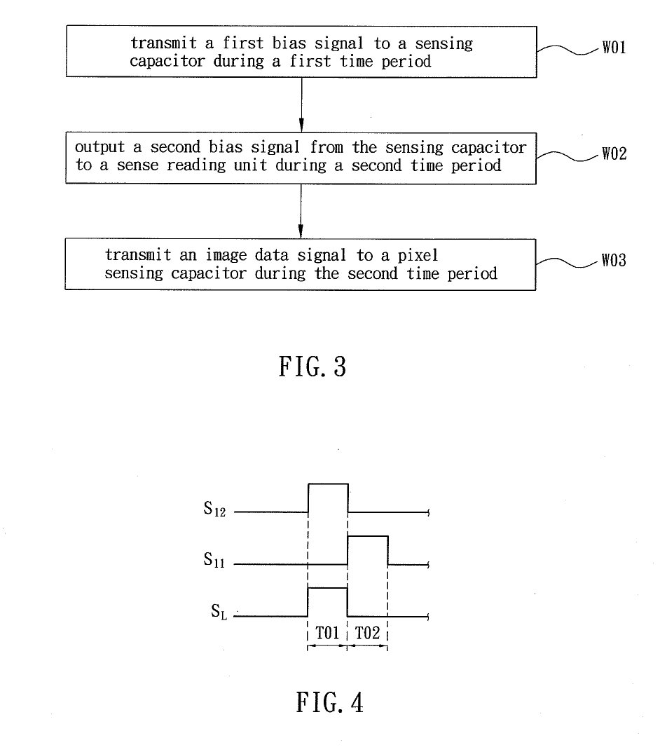

Referring again to FIG. 3, a control method of the touch panel according to the first embodiment of the invention includes steps W01 to W03.

Illustrations will be made with reference to FIGS. 3 and 4. In the step W01, a first bias signal is transmitted to the sensing capacitor C₁₂ during a first time period T01. In this embodiment, a second scan signal (S₁₂ in FIG. 4) is transmitted from the scan control circuit 12 through the second scan line S₁₂ so that the touch choosing switch T₁₂ turns on, and then the first bias signal is transmitted from the scan control circuit 12 to the sensing capacitor C₁₂ through the bias line B₁₁ and the touch choosing switch T₁₂. The read switch T₁₃ remains turned off during the first time period T01. Thus, the sensing capacitor C₁₂ is charged by the first bias signal.

In addition, it is to be noted that the operational capacitor C_{fb} stores the charges outputted from the previous scan during the first time period T01. Therefore, the switch L is controlled to be closed by a switching signal (S_{L} in FIG. 4) transmitted (by a control circuit, for example, data control circuit 11 or scan control circuit 12) through a switch signal line S_{L} so that the operational capacitor C_{fb} discharges to reset the state of the operational capacitor C_{fb}.

In the steps W02 and W03, the sensing capacitor C₁₂ outputs a second bias signal V_{b} to the sense reading unit 131 via read line R₁, and an image data signal is transmitted to the pixel sensing capacitor C₁₁ during a second time period T02 which is the displaying period. In this embodiment, during the second time period T02, the second scan signal is removed from the second scan line S₁₂ so that the touch choosing switch T₁₂ turns off. A first scan signal (S₁₁ in FIG. 4) is transmitted from the scan control circuit 12 through the first scan line S₁₁ so that the pixel switch T₁₁ turns on. When the pixel switch T₁₁ turns on, image data is transmitted from the data control circuit 11 to the liquid crystal capacitor C_{LC1} through the data line D₁₁ and the pixel switch T₁₁. The first scan signal on the first scan line S₁₁ also turns on the read switch T₁₃ so that the sensing capacitor C₁₂ discharges and outputs the second bias signal V_{b} to the sense reading unit 131 through the read switch T₁₃ and read line R₁.

The negative input terminal of the operational amplifier OP of the sense reading unit 131 receives the second bias signal V_{b}, and the positive input terminal of the operational amplifier OP of the sense reading unit 131 receives a reference signal V_{ref}. The operational amplifier OP outputs a sensed output value Vₒ according to the second bias signal V_{b} and the reference signal V_{ref}, wherein the sensed output value Vₒ is represented by:

$$Vo = \frac{{\int }_{0}^{t} i \times d t}{{C}_{fb}} = \frac{{\int }_{0}^{t} d Q}{{C}_{fb}} = \frac{{\int }_{0}^{t} C 12 \times d V}{{C}_{fb}} = \frac{C 12}{{C}_{fb}} ( Vref - Vb ) .$$

The position judging unit 132 judges which pixel 2 is touched according to the sensed output value Vₒ outputted from the respective sense reading unit 131 and a timing signal of the scan line.

In addition, the first bias signal is the same as the second bias signal V_{b} in this embodiment when the capacitance of the sensing capacitor C₁₂ is unchanged during the time periods T01 and T02, i.e., when the respective pixel of the touch panel 1 is not applied with an external force. Correspondingly, if the touch panel 1 is applied with the external force, the first bias signal is different from the second bias signal V_{b}. Herein, the so-called external force represents the external force capable of changing the capacitance of the sensing capacitor C₁₂. For example, the force may be applied to change the gap of the sensing capacitor C₁₂, or the touch of the human body may change the capacitance of a varactor C_{T}.

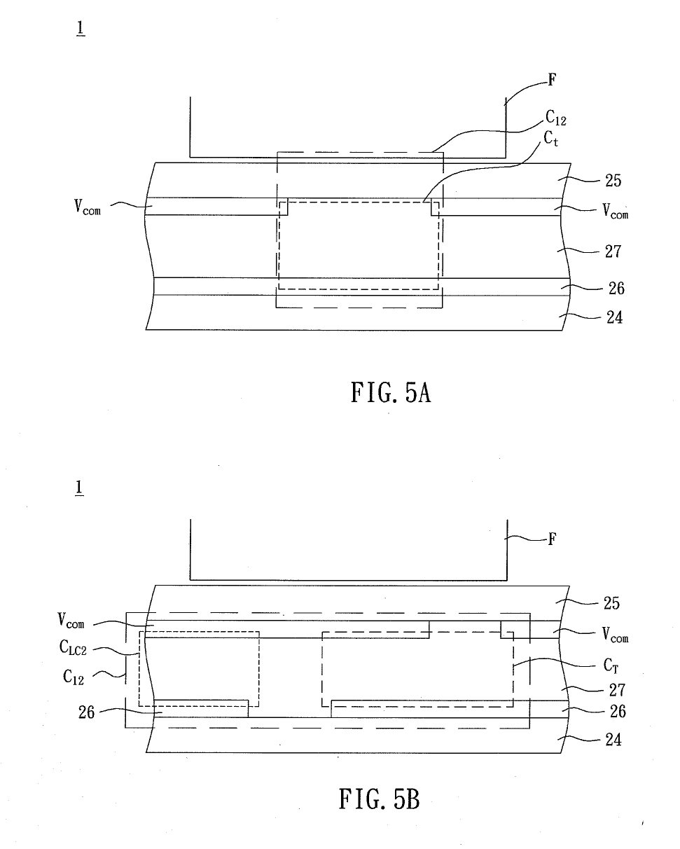

In practice, the sensing capacitor C₁₂ may have various structures as exemplarily shown in FIGS. 5A and 5B. The touch panel 1 includes a transistor substrate 24, a color filtering substrate 25, a pixel electrode 26 and a common electrode V_{com}. The sensing capacitor C₁₂ is formed at the position shown in the drawing. As shown in FIG. 5A, when the user applies an external force F to the touch panel 1, the capacitance of the sensing capacitor C₁₂ is changed by a value equal to the capacitance variation of the varactor C_{T} only, because liquid crystal capacitor C_{LC2} is not provided in the structure of FIG. 5A. As shown in FIG. 5B, when the user applies an external force F to the touch panel 1, the capacitance of the sensing capacitor C₁₂ is changed by a value equal to a sum of the capacitance variations of both the liquid crystal capacitor C_{LC2} and the varactor C_{T}.

Although not shown in FIGS. 5A and 5B, an alternative structure of the sensing capacitor C₁₂ can also be used in this embodiment when the common electrode V_{com} and the transistor substrate 24 have the same structure size, i.e., the varactor C_{T} cannot function for the judgment of the touched position. In this alternative structure, only the liquid crystal capacitor C_{LC2} can function for the judgment of the touched position. That is, the sensing capacitor C₁₂ cannot become effective until a force F is applied. When the common electrode V_{com} has a discontinuous structure, as shown in FIG. 5A or 5B, both the liquid crystal capacitor C_{LC2} and the varactor C_{T} (FIG. 5B) or only the varactor C_{T} (FIG. 5A) may function for the judgment of the touched position.

### Second Embodiment

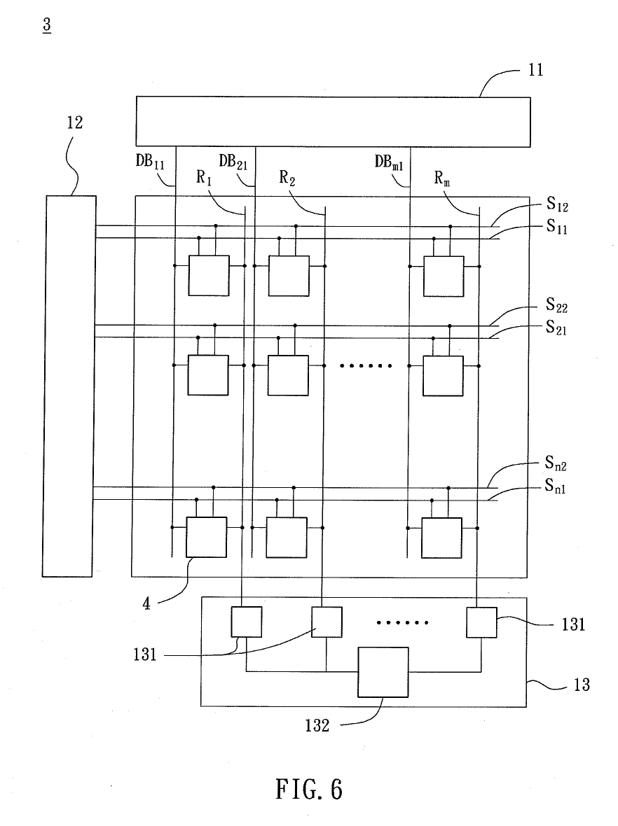

The touch panel and the control method thereof according to a second embodiment of the invention will be described in the following section. Referring to FIG. 6, a touch panel 3 according to the second embodiment of the invention includes a plurality of pixels 4, a data control circuit 11, a scan control circuit 12 and a touch control circuit 13.

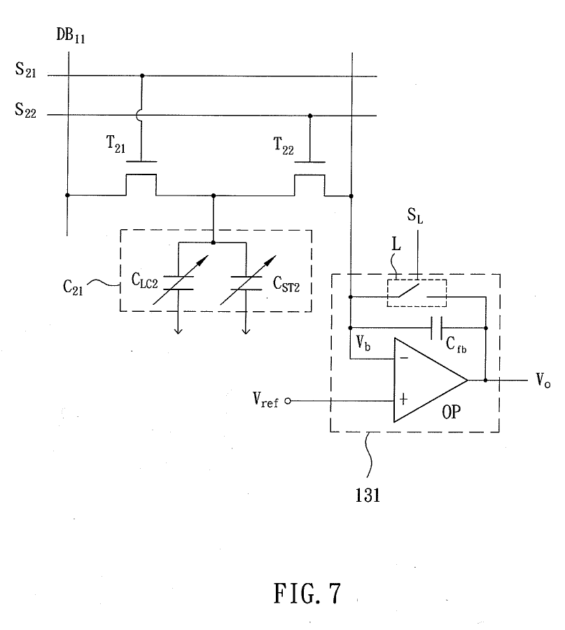

Referring to FIG. 7, the pixel 4 according to the second embodiment of the invention includes a pixel switch T₂₁, a touch choosing switch T₂₂ and a pixel/sensing capacitor C₂₁. The pixel switch T₂₁ is electrically connected with a first scan line S₂₁ and a data and bias line DB₁₁. The pixel/sensing capacitor C₂₁ is electrically connected with the pixel switch T₂₁, and the touch choosing switch T₂₂. In practice, the pixel/sensing capacitor C₂₁ includes a liquid crystal capacitor C_{LC2} and a storage capacitor C_{ST2} electrically connected with each other.

In this embodiment, the touch panel 3 further includes a sense reading unit 131, which is the same as that of the first embodiment, and a negative input terminal of an operational amplifier OP is electrically connected with the touch choosing switch T₂₂.

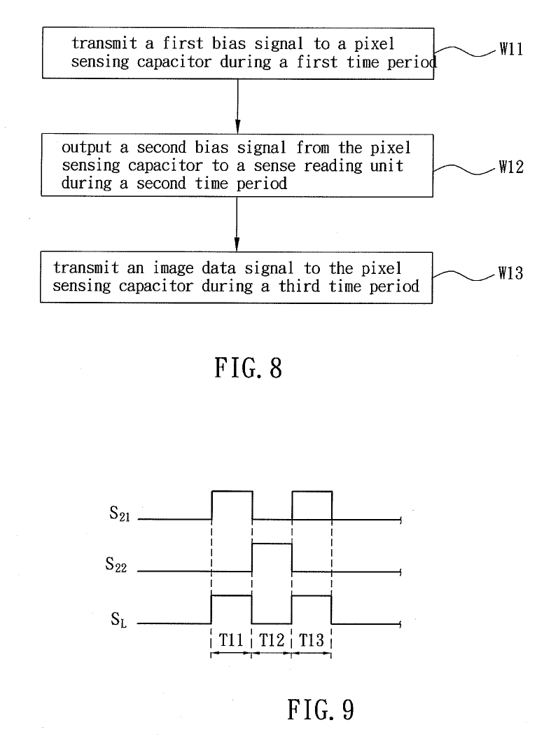

Referring further to FIG. 8, the control method of the touch panel according to the second embodiment of the invention includes steps W11 to W13.

Illustrations will be made with reference to FIGS. 8 and 9. In the step W11, a first scan signal (S₂₁ in FIG. 9) is transmitted from the scan control circuit 12 through the first scan line S₂₁ during a first time period T11 so that the pixel switch T₂₁ turns on. At this time, a first bias signal is transmitted from the data control circuit 11 to the pixel/sensing capacitor C₂₁ through the pixel switch T₂₁, and the data and bias line DB₁₁. The touch choosing switch T₂₂ remains turned off during the first time period T01. Thus, the pixel/sensing capacitor C₁₂ is charged by the first bias signal.

In the step W12, a second scan signal (S₂₂ in FIG. 9) is transmitted from the scan control circuit 12 through the second scan line S₂₂ during a second time period T12 so that the touch choosing switch T₂₂ turns on. During the second time period T12, the first scan signal is removed from the first scan line S₂₁ so that the pixel switch T₂₁ turns off. As the touch choosing switch T₂₂ turns on, the pixel/sensing capacitor C₂₁ discharges and outputs a second bias signal V_{b}, which is transmitted to the negative input terminal of the operational amplifier OP of the sense reading unit 131 through the touch choosing switch T₂₂. If the pixel sensing capacitor C₂₁ is not applied with an external force, the first bias signal is the same as the second bias signal V_{b}. One of ordinary skill in the art may easily understand the operation condition of the sense reading unit 131 according to the illustration made in the first embodiment, so detailed descriptions thereof will be omitted.

In the step W13, an image data signal is transmitted from the data control circuit 11 during a third time period T13 which is the displaying period. Herein, the first scan signal (S₂₁ in FIG. 9) is again transmitted through the first scan line S₂₁ so that the pixel switch T₂₁ turns on, and the image data signal is transmitted to the pixel/sensing capacitor C₂₁ through the data and bias line DB₁₁ and the pixel switch T₂₁. As shown in FIG. 9, during the time periods T11 and T13, the switching signal (S_{L} in FIG. 9) is transmitted (by a control circuit, for example, data control circuit 11 or scan control circuit 12) so as to reset the state of the operational capacitor C_{fb} similarly to the first embodiment.

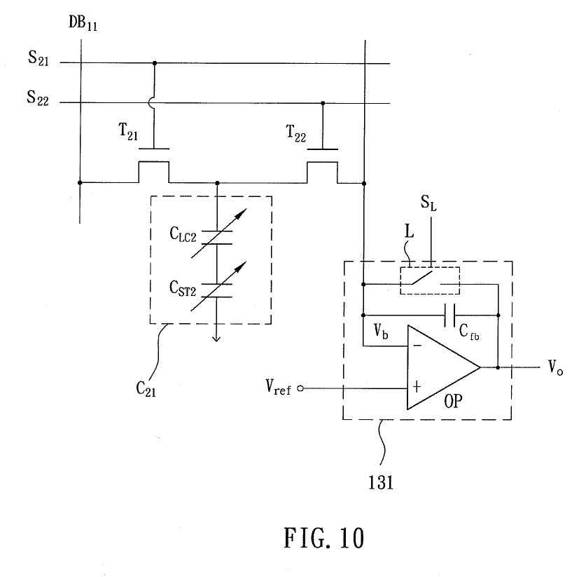

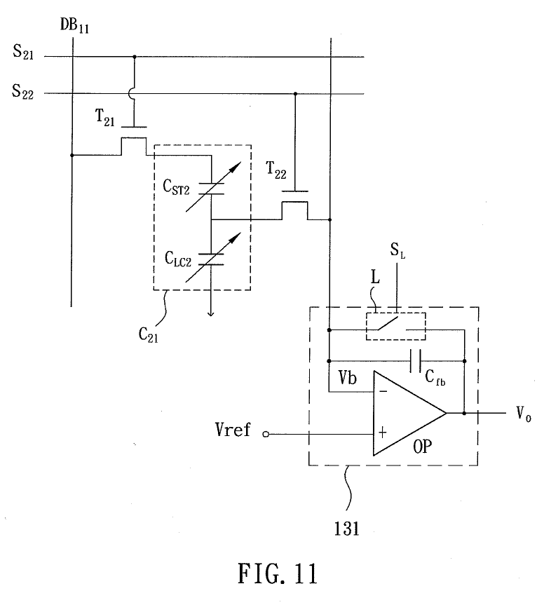

In addition, this embodiment does not intend to restrict the connection between the liquid crystal capacitor C_{LC2} and the storage capacitor C_{ST2} to be within the pixel/sensing capacitor C₂₁. In addition to the parallel connection of FIG. 7, the liquid crystal capacitor C_{LC2} and the storage capacitor C_{ST2} may also be connected in series, as shown in FIG. 10, or may be connected in a manner as shown in FIG. 11.

In summary, in the touch panel and the control method thereof according to embodiments of the invention, when an external force is applied to or a human body contacts (conductor contact) with the sensing capacitor or the pixel/sensing capacitor of a pixel, the capacitance thereof is changed so that a determination as to whether the touch panel is touched and/or the touched position can be made. Compared with the prior art, a photonic transistor is not used in the touch panel of embodiments of the invention to sense the touched position. Therefore, embodiments of the invention are free from the interferences of external light sources. Further, the service life of the touch panel in accordance with the disclosed embodiments is improved as the lifespan of the disclosed transistor is also longer than that of the conventional photonic transistor.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A touch panel, comprising:
a controller;
at least one pixel which comprises
a touch choosing switch coupled to and controlled by the controller to turn on during a first time period and turn off during a second time period;
a read switch coupled to and controlled by the controller to turn off during the first time period and turn on during the second time period; and
a sensing capacitor having a touch-sensitive capacitance and being electrically connected with the touch choosing switch and the read switch to be charged, via the touch choosing switch, with a sensing charge during the first time period and to discharge the sensing charge, via the read switch during the second time period; and
a sense reading unit electrically connected with the sensing capacitor via the read switch for outputting a sensed output value during the second time period;
wherein the sensed output value is indicative of the whether the capacitance of the sensing capacitor has changed between the first and second periods, thereby indicating whether said pixel of the touch panel has been touched.

2. The touch panel according to claim 1, wherein a gap of the sensing capacitor is changeable by an external force applied to said pixel.

3. The touch panel according to claim 1, wherein the sense reading unit is an integrator.

4. The touch panel according to claim 1, wherein the sense reading unit comprises:
an operational amplifier having a positive input terminal, a negative input terminal and an output terminal, wherein the negative input terminal is connected with the sensing capacitor via the read switch for receiving a second bias signal generated by the sensing capacitor discharging said sensing charge, the positive input terminal receives a reference signal, and the operational amplifier outputs the sensed output value according to the second bias signal and the reference signal;
an operational capacitor connected between the negative input terminal and the output terminal of the operational amplifier; and
a controllable switch connected in parallel with the operational capacitor for resetting the operational capacitor after the switch turns on.

5. The touch panel according to claim 1, further comprising:
a position judging unit coupled to the sense reading unit for judging the touched position according to the sensed output value.

6. A touch panel, comprising at least one pixel having a first scan line, a second scan line, and a bias line, said at least one pixel further comprising:
a touch choosing switch,
a read switch, and
a sensing capacitor having a touch-sensitive capacitance,
wherein
the touch choosing switch is electrically connected with the first scan line and the bias line,
the read switch is electrically connected with the second scan line, and
the sensing capacitor is electrically connected with both the touch choosing switch and the read switch, for receiving a first bias signal from the bias line through the touch choosing switch during a first period and for outputting a second bias signal through the read switch during a second period different from the first period, wherein the second bias signal is indicative of the whether the capacitance of the sensing capacitor has changed between the first and second periods, thereby indicating whether said pixel of the touch panel has been touched.

7. The touch panel according to claim 6, wherein a gap of the sensing capacitor is changeable by an external force applied to said pixel.

8. The touch panel according to claim 6, wherein said pixel further comprises
a pixel switch electrically connected to the second scan line and a data line of the touch panel; and
a pixel capacitor electrically connected to the pixel switch for displaying image data received from the data line via the pixel switch during the second period.

9. The touch panel according to claim 8, further comprising:
a scan control circuit electrically connected with the touch choosing switch, the read switch and the pixel switch through the first scan line, the second scan line and the bias line;
a data control circuit electrically connected with the pixel switch through the data line.

10. The touch panel according to claim 8, wherein the sensing capacitor comprises a liquid crystal capacitor and a varactor electrically connected with each other, and the pixel capacitor comprises another liquid crystal capacitor and a storage capacitor electrically connected with each other.

11. The touch panel according to claim 6, further comprising:
a scan control circuit electrically connected with the pixel switch and the touch choosing switch through the second scan line and the first scan line, respectively;
a data control circuit electrically connected with the pixel switch through the bias line which is also a data line;
wherein said sensing capacitor is configured as pixel capacitor for displaying image data received from the data line via the pixel switch during a third period different from the first and second periods.

12. The touch panel according to claim 11, wherein the sensing capacitor comprises a liquid crystal capacitor and a storage capacitor electrically connected with each other.

13. The touch panel according to claim 6, further comprising:
a sense reading unit electrically connected with the read switch for outputting a sensed output value according to the second bias signal.

14. The touch panel according to claim 13, wherein the sense reading unit is an integrator.

15. The touch panel according to claim 13, wherein the sense reading unit comprises:
an operational amplifier having a positive input terminal, a negative input terminal and an output terminal, wherein the negative input terminal is connected with the sensing capacitor via the read switch for receiving the second bias signal, the positive input terminal receives a reference signal, and the operational amplifier outputs the sensed output value according to the second bias signal and the reference signal;
an operational capacitor connected between the negative input terminal and the output terminal of the operational amplifier; and
a controllable switch connected in parallel with the operational capacitor for resetting the operational capacitor after the switch turns on.

16. The touch panel according to claim 12, wherein the liquid crystal capacitor and the storage capacitor are connected in series or in parallel.

17. A control method of a touch panel, the touch panel having at least one pixel that comprises a sensing capacitor having a touch-sensitive capacitance, the control method comprising:
transmitting a first bias signal to the sensing capacitor during a first time period to charge the sensing capacitor with a sensing charge;
causing the sensing capacitor to discharge the sensing charge as an outputted second bias signal during a second time period different from the first time period; and
based on the second bias signal, determining whether the capacitance of the sensing capacitor has changed between the first and second periods, thereby indicating whether said pixel of the touch panel has been touched.

18. The control method according to claim 17, further comprising transmitting an image data signal to a pixel capacitor of said at least one pixel during the second time period.

19. The control method according to claim 17, further comprising transmitting an image data signal to the sensing capacitor, which is also a pixel capacitor, during a third time period different from the first and second periods.

20. The control method according to claim 17, wherein an external force is applied for changing a gap of the sensing capacitor.
